(19) United States
(12) Patent Application Publication
(10) Pub. No.: US 2025/0223857 A1
(43) Pub. Date: Jul. 10, 2025

(54) METHOD FOR OPERATING A CLOSURE ELEMENT ARRANGEMENT OF A MOTOR VEHICLE

(71) Applicant: Brose Fahrzeugteile SE & Co. Kommanditgesellschaft, Bamberg, Bamberg (DE)

(72) Inventors: Ryohei Higuchi, Kanagawa (JP); Takahashi Hisanobu, Yokohama (JP)

(21) Appl. No.: 19/008,147

(22) Filed: Jan. 2, 2025

(30) Foreign Application Priority Data
Jan. 5, 2024 (DE) 10 2024 100 251.4

(51) Int. Cl. E05F 15/40; E05F 15/73

(52) U.S. Cl. CPC E05F 15/40; E05F 15/73; E05Y 2400/456; E05Y 2400/54; E05Y 2900/546

(57) ABSTRACT

A method for operating a closure element arrangement of a motor vehicle, wherein the closure element arrangement has a closure element, a drive arrangement assigned to the closure element for adjusting the closure element in an adjustment range and a control arrangement for actuating the drive, wherein sensor values are detected by means of a sensor arrangement in a detection zone with respect to an operator action carried out by an operator outside the motor vehicle, wherein the detected sensor values are checked by means of the control arrangement in a check routine for the presence of a valid operator action, wherein the drive arrangement is caused by means of the control arrangement to adjust the closure element in an adjustment direction when a valid operator action is present, and wherein a closure element position of the closure element is determined by means of the control arrangement.

### CLAIM OF PRIORITY

This application claims priority to German patent application DE 10 2024 100 251.4, entitled “Method for Operating a Closure Element Arrangement of a Motor Vehicle,” filed Jan. 5, 2024, the disclosure of which is incorporated herein by reference.

### FIELD OF THE TECHNOLOGY

Various embodiments relate to a method for operating a closure element arrangement of a motor vehicle, to a control arrangement for a closure element arrangement of a motor vehicle, and to such a closure element arrangement.

### BACKGROUND

The known prior art (DE 10 2017 129 151 A1), from which some embodiments proceed, relates to a method for operating a closure element arrangement via a predefined operator action, which can be formed by a foot movement of the operator. An actuation detected as a valid operator action leads to an actuation of a drive arrangement for the closure element, so that the operator can, for example, open and close a flap or door of the motor vehicle contactlessly.

In the known method (DE 10 2017 129 151 A1), an operator action is detected with a sensor arrangement via sensor values, wherein a valid operator action can be given by permitted ranges of sensor values or values derived from these. The challenge here is to ensure that operator actions are detected with a high degree of reliability in order to increase convenience. At the same time, undesired triggering of the motorized adjustment, which may even involve a collision risk for the operator, must be prevented.

### SUMMARY

Various embodiments are based on the problem of designing and developing the known method in such a way that the detection of the operator action for triggering the motorized adjustment is improved while at the same time maintaining a high level of safety for the operator.

The above problem is solved by various features described herein.

The motorized closure element of the closure element arrangement can be any closure element of a motor vehicle. These include tailgates, luggage compartment lids, hoods, in particular engine hoods, doors, in particular side or rear doors, or the like. The closure element can be pivotably or longitudinally displaceably arranged on the motor vehicle body.

Sensor values detected by a sensor arrangement are checked here for the presence of a valid operator action by means of a control arrangement in a check routine. The fundamental consideration is that the check routine should be designed to be dependent on the existing closure element position, the execution position of the operator action and the intended direction of adjustment with the triggering. It has been found that the risk of collision between the moving closure element and the operator performing the operator action can be reliably assessed by evaluating these factors together. The sensitivity in the check routine can be adapted in such a way that increased requirements are placed on the detection of a valid operator action if there is a risk of collision.

Specifically, it is proposed that the check routine is modified by means of the control arrangement depending on a relation of the closure element position to an execution position of the detected operator action determined on the basis of the sensor values, taking into account the intended adjustment direction.

In various embodiments, positions in the detection zone are assigned a collision risk in this way, which can be used as the basis for modifying the check routine. In particular, a higher risk of collision can be assumed if the execution position and closure element position are close together in some embodiments.

Of interest is the definition of a danger zone according to some embodiments, whereby positions in the detection zone are characterized in a simple manner with regard to the risk of collision. In various embodiments, the detection zone can be divided into a danger zone and a less critical distance zone.

Furthermore, in various embodiments, a far range of the detection zone is defined, for which a sufficiently low risk of collision is expected, so that only reduced requirements are placed on the detection of a valid operator action in the far range.

In general, the modification of the check routine can be made depending on the respective collision risk with regard to a detection probability of a valid operator action, which is the subject of some embodiments.

Various embodiments with regard to the check routine and its modification are also provided herein.

According to various embodiments, a control arrangement for a closure element arrangement of a motor vehicle is provided. It can be that the control arrangement modifies the check routine depending on a relation of the closure element position to an execution position of the detected operator action determined on the basis of the sensor values, taking into account the intended adjustment direction. Reference may be made to all explanations of the proposed method.

According to various embodiments, a closure element arrangement for a motor vehicle is provided. The closure element arrangement is designed to carry out the proposed method. Reference may be made to all explanations of the proposed method and the proposed control arrangement.

Various embodiments provide a method for operating a closure element arrangement of a motor vehicle, the closure element arrangement having a closure element, a drive arrangement assigned to the closure element for displacing the closure element in an adjustment range, and a control arrangement for actuating the drive arrangement, sensor values being detected by means of a sensor arrangement in a detection zone with respect to an operator action carried out by an operator outside the motor vehicle, the detected sensor values being checked by means of the control arrangement in a check routine for the presence of a valid operator action, and, if a valid operator action is present, the drive arrangement being caused by means of the control arrangement to displace the closure element in a displacement direction, and a closure element position of the closure element being determined by means of the control arrangement, wherein the check routine is modified by means of the control arrangement depending on a relation of the closure element position to an execution position of the detected operator action determined on the basis of the sensor values, taking into account the intended adjustment direction.

In various embodiments, a collision risk is assigned to positions in the detection zone relative to the closure element position by means of the control arrangement, taking into account the intended adjustment direction, and wherein the check routine is modified depending on the collision risk assigned to the execution position.

In various embodiments, starting from the closure element position, a greater risk of collision is assigned to positions close to the closure element position in the direction of displacement than to positions remote from the closure element position, in some embodiments, in that, starting from the closure element position, a lower risk of collision is assigned to positions opposite the direction of displacement than to positions in the direction of displacement.

In various embodiments, a danger zone located at the closure element position is defined by means of the control arrangement in the detection zone, taking into account the intended adjustment direction, and wherein positions within the danger zone are assigned a higher risk of collision than positions outside the danger zone.

In various embodiments, the adjustment range is divided into the danger zone and a distance zone, and wherein positions within the danger zone are assigned a higher risk of collision than positions in the distance zone.

In various embodiments, a far range is defined in the detection zone, and wherein positions within the far range are assigned a lower risk of collision than positions outside the far range. In some embodiments, the far range is defined outside the adjustment range.

In various embodiments, the check routine is modified in such a way that a lower probability of detection of a valid operator action is achieved with a higher, assigned collision risk than with a lower, assigned collision risk.

In various embodiments, an operator action model with characteristic values is assigned to the valid operator action, wherein it is checked by means of the control arrangement as part of the check routine whether the sensor values correspond to the characteristic values of the operator action model, and wherein the operator action model is generated and/or parameterized as a function of the relation of the closure element position to the execution position, taking into account the intended adjustment direction.

In various embodiments, a recognition quality for the detected operator action is determined on the basis of the characteristic values of the set of characteristic values, wherein the operator action is classified as a valid operator action or rejected on the basis of the recognition quality, and wherein the determination of the recognition quality and/or at least one threshold value for the recognition quality is modified as a function of the relation of the closure element position to the execution position, taking into account the intended adjustment direction.

In various embodiments, in the check routine the sensor values are fed as input values to a trained machine learning model, wherein the presence of a valid operator action is assessed on the basis of at least one output value of the trained machine learning model, and wherein the trained machine learning model and/or the input values is or are dependent on the relation of the closure element position to the execution position, taking into account the intended adjustment direction.

Various embodiments provide a control arrangement for a closure element arrangement of a motor vehicle, the control arrangement being coupled in the assembled state to a sensor arrangement which detects sensor values in a detection zone with respect to an operator action carried out by an operator outside the motor vehicle, the control arrangement checking the detected sensor values in a check routine for the presence of a valid operator action, the control arrangement causing a drive arrangement of the closure element arrangement to adjust a closure element of the motor vehicle in an adjustment direction when a valid operator action is present, and the control arrangement determining a closure element position of the closure element, wherein the control arrangement modifies the check routine depending on a relation of the closure element position to an execution position of the detected operator action determined on the basis of the sensor values, taking into account the intended adjustment direction.

In various embodiments, the closure element arrangement being set up to carry out the method as provided herein.

### BRIEF DESCRIPTION OF THE DRAWINGS

In the following, various aspects are explained in greater detail with the aid of a drawing showing only exemplary embodiments, in which

FIG. 1 shows a side view of a motor vehicle with an operator as part of the proposed method,

FIG. 2 shows the motor vehicle from FIG. 1 with zones for the execution position during an opening process and

FIG. 3 shows the motor vehicle from FIG. 1 with zones for the execution position during a closing process.

### DETAILED DESCRIPTION

The exemplary embodiment shown in the figures relates to a method for operating a closure element arrangement 1 of a motor vehicle 2. The closure element arrangement 1 has a closure element 3 and a drive arrangement 4 assigned to the closure element 3 for adjusting the closure element 3 in an adjustment range.

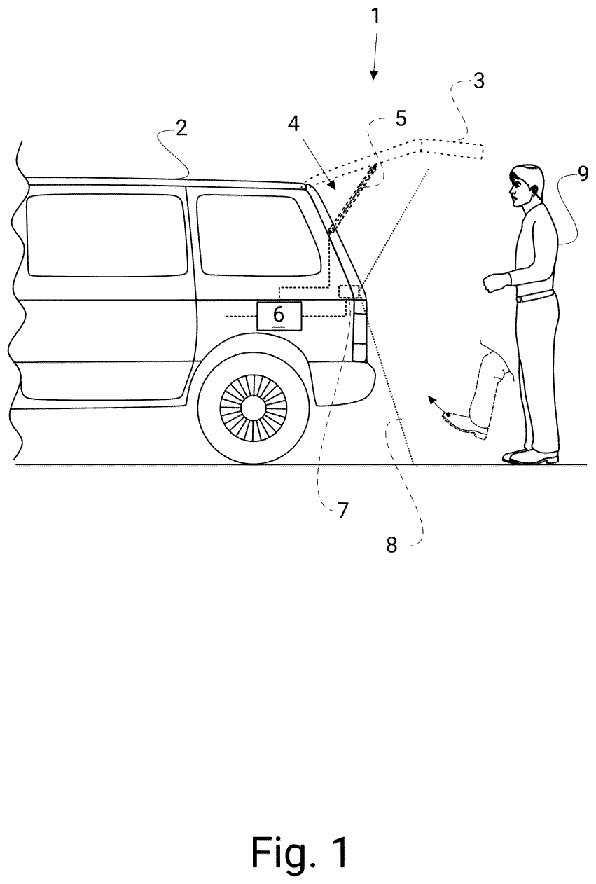

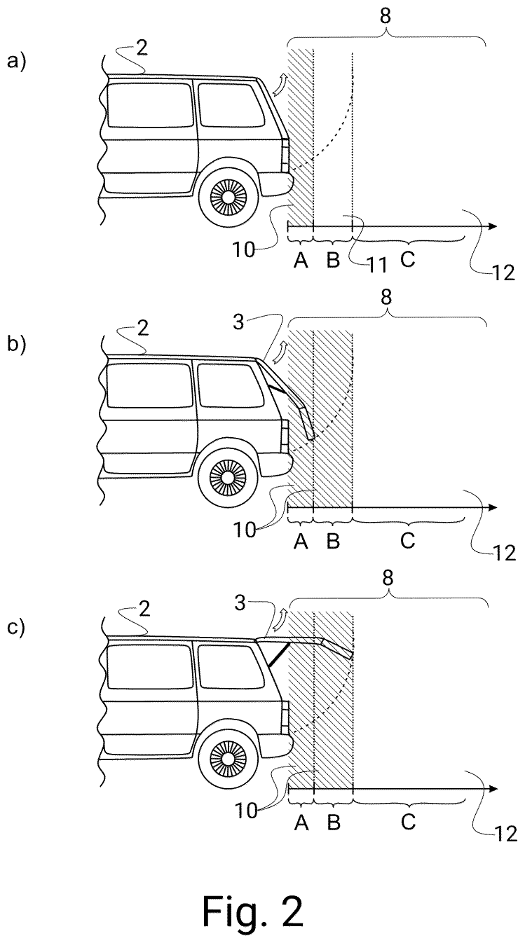

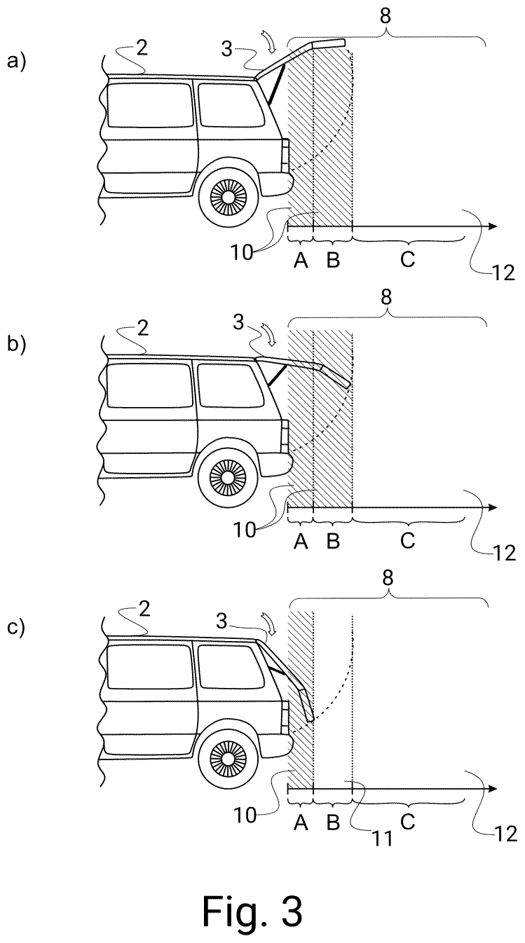

In the illustrated exemplary embodiment, the drive arrangement 4 is provided for moving the closure element 3 from a closed position to the open position shown with a dashed line in FIG. 1. Such an opening process is further illustrated in FIG. 2. Furthermore, the drive arrangement 4 is provided for moving the closure element 3 from the open position to the closed position, which is shown as a closing process in FIG. 3. The adjustment can also take place from at least one intermediate position between the open position and the closed position as well as into an intermediate position. For possible configurations of the closure element 3, please refer to the introductory comments, wherein the closure element 3 is shown here according to a configuration as a tailgate.

The drive arrangement 4 generally has a drive 5 with actuator, which is set up to adjust the closure element 3 by an adjustment kinematics system associated with the closure element 3. The actuator can be designed as an electric motor, which exerts a driving force on the closure element 3, for example via a rotary gear and/or linear gear. In principle, the drive arrangement 4 can have several drives 5 for the closure element 3, wherein, for example, drives 5, in particular spindle drives, are arranged on opposite sides of the tailgate. The adjustment kinematics combine the components that allow the closure element 3 to be adjusted between different positions. In the exemplary embodiment shown, the adjustment kinematics include a hinge for the pivotable closure element 3. The adjustment range is given by the area on the motor vehicle 2 which is covered by the closure element 3 during the adjustment process.

The closure element arrangement 1 has a control arrangement 6 for controlling the drive arrangement 4. The control arrangement 6 is equipped with an electronic control unit, which performs the control tasks during motorized adjustment and, for example, initiates the supply of an electrical drive voltage to the drive arrangement 4. The control arrangement 6 can perform further functions in relation to the closure element arrangement 1 and actuate further components of the closure element arrangement 1 and, for example, initiate the opening of a motor vehicle lock associated with the closure element 3.

A sensor arrangement 7 is used to detect sensor values in a detection zone 8 relating to an operator action performed by an operator 9 outside the motor vehicle 2. An operator action is generally understood to be a time-dependent action of the operator 9, in particular a movement pattern of a body part of the operator 9 such as an operator gesture. In embodiments, the sensor arrangement 7 can have an ultrasonic sensor, radar sensor, lidar sensor, an optical sensor such as a camera and/or an ultrasonic sensor for detection.

The sensor values can be generally representative of the position of objects outside the motor vehicle 2. For example, the sensor values contain distance information and, in particular, directional information between the detected object, including the operator 9, and the motor vehicle 2. The detected sensor values are checked for the presence of a valid operator action by means of the control arrangement 6 in a check routine. Here, the sensor values are assessed by the control arrangement 6 using a predefined checking system of the check routine to determine whether an action of an object detected in the sensor values sufficiently corresponds to a specification for a valid operator action. Depending on the result of the check, the operator action detected via the sensor values is either rejected as invalid or qualified as a valid operator action.

The valid operator action can be an operator gesture with a specific time sequence. The operator action 9 is provided, for example, by a predetermined foot movement such as a kicking movement and/or a predetermined hand movement such as a wiping movement or a predetermined approach of the hand to the closure element 3.

When a valid operator action is present, the drive arrangement 4 is triggered by the control arrangement 6 to adjust the closure element 3 in an adjustment direction. In addition to the presence of the valid operator action, the execution of the motorized adjustment can be linked to further conditions, for example to a closed state of the closure element arrangement 1 (locked/unlocked) and/or the detection of an electronic key. Corresponding conditions can in turn be checked by the control arrangement 6 or by other control components coupled to the flap arrangement, such as a flap control unit, door control unit or similar. Furthermore, the motorized adjustment can be controlled by a drive control of the drive arrangement 4. The control arrangement 6 can be centralized as shown and, for example, be part of a door control unit, flap control unit or the like. The control arrangement 6 can also be at least partially integrated into the drive 5 or the drive control 5 of the drive arrangement 4 or into the sensor arrangement 7.

A closure element position of the closure element 3 is determined by means of the control arrangement 6. The closure element position can be detected by sensors, for example via a position sensor of the closure element 3. The closure element position can be mapped here via the position of the closure element 3, for example an angular position in the case of the pivoting tailgate shown in the figures, by which the closure element position is otherwise determined relative to the motor vehicle 2. The closure element position can also be detected via the actuation of the drive arrangement 4, for example using electrical drive values such as the drive current and/or drive voltage of the drive arrangement 4 during actuation. Examples of this are ripple detection for the drive current and the use of a motor model to determine a motor position from which the position of the closure element can be derived.

It is now essential that the check routine is modified by means of the control arrangement 6 depending on a relation of the closure element position to an execution position of the detected operator action determined on the basis of the sensor values, taking into account the intended adjustment direction.

The relation is generally understood to mean that the determined closure element position is set in relation to the execution position in order to modify the check routine. In particular, the modification is made on the basis of a relative position given by the closure element position and the execution position. The execution position is a characteristic position of the detected operator action and can, for example, be given by a temporal and/or spatial average of detected sensor targets to be assigned to the operator action. The modification is also dependent on the adjustment direction provided for the motorized adjustment, which means that the modification is carried out in different ways depending on whether a closing operation or an opening operation of the closure element 3 is to be triggered. In particular, a distinction is made as to whether the execution position relative to the closure element position is in the direction of adjustment or against the direction of adjustment.

It can be that the control arrangement 6 is used to assign a collision risk to positions in the detection zone 8 relative to the closure element position, taking into account the intended adjustment direction, and that the check routine is modified depending on the collision risk assigned to the execution position.

The closure element position is used here as a reference for assigning the risk of collision to the positions. For example, the risk of collision is a function of the distance between the respective position and the closure element 3. The distance can be assumed to be a minimum distance from the surface of the closure element 3. The assignment of the risk of collision relative to the closure element position is used to implement the aforementioned relationship between the closure element position and the execution position, wherein a further distinction is made between the adjustment directions for the assignment.

Starting from the closure element position, a greater risk of collision can be assigned to positions close to the closure element position in the adjustment direction than to positions away from the closure element position. This takes account of the fact that objects detected close to the closure element 3 can generally pose a higher risk of collision in the direction of movement.

In a further embodiment, starting from the closure element position, positions against the direction of adjustment are assigned a lower risk of collision than positions in the direction of adjustment. In particular, a low risk of collision can be assumed for positions against the direction of adjustment, as the motorized adjustment tends to move the closure element 3 away from such positions.

It is conceivable that the risk of collision is a continuous function of the position relative to the closure element position. However, areas with a respective risk of collision can also be defined for the detection zone 8. In particular, a geometry of areas in the detection zone 8 is predefined, to which a respective collision risk is assigned depending on the closure element position and the adjustment direction.

FIGS. 2 and 3 show the zones A, B, C, which are otherwise defined in the detection zone 8 relative to the motor vehicle 2. In various embodiments, the zones A, B, C are defined by a horizontal distance to a reference position on the motor vehicle 2, for example the position of the sensor arrangement 7 in relation to the horizontal. Depending on the closure element position and the intended adjustment direction, a collision risk is assigned to the zones A, B, C in each case. In this respect, a distinction is made between an opening process (FIG. 2) and a closing process (FIG. 3) of the closure element 3 and the respective closure element positions present in the assignment.

In various embodiments, the control arrangement 6 is used to define a danger zone 10 located at the closure element position in the detection zone 8, taking into account the intended adjustment direction, and that positions within the danger zone 10 are assigned a higher risk of collision than positions outside the danger zone 10.

In the opening process shown in FIG. 2, the area located at the closure element 3 in the opening direction is defined as the danger zone 10. In FIG. 2a), an opening process starting from a closed position is provided as a closure element position, wherein the zone A located at the closure element 3 in the opening direction is defined as danger zone 10. A lower risk of collision is assigned to zones B and C. If the opening process is carried out from the partially open position shown in FIG. 2b) as a closure element position, zone B is defined as danger zone 10, which is located here at the closure element 3 in the opening direction. Zone A can also be defined here as danger zone 10, since in this zone, for example, a foot movement of an operator 9 can be carried out, who is otherwise located in zone B. FIG. 2c) shows a further open position as a closure element position, wherein zones A and B are also defined here as danger zone 10.

FIG. 3 shows the situation for a closing operation, wherein in FIG. 3a) the closing operation is triggered from the closure element 3 in the open position. Due to the risk of collision or entrapment of the operator 9, zones A and B are defined here as danger zone 10. When triggering from an intermediate position of the closure element 3, a distinction can be made in principle according to the existing closure element position for the definition of the danger zone 10. In FIG. 3b), the closure element position is a position close to the open position and zones A and B are defined as danger zone 10. In FIG. 3c), only zone A is in the adjustment direction starting from the closure element position, so that only zone A is defined as danger zone 10.

In principle, additional gradations of collision risk can be made for zones. For example, the adjustment range can be divided into the danger zone 10 and a distance zone 11, and positions within the danger zone 10 can be assigned a higher risk of collision than positions in the distance zone 11. For example, zone B in FIG. 2a) and zone A in FIG. 3a) can be defined as such a distance zone 11.

In various embodiments it is provided that a far range 12 is defined in the detection zone 8, and that positions within the far range 12 are assigned a lower risk of collision than positions outside the far range 12. The definition of the far range 12 can be independent of the closure element position. In various embodiments, the far range 12 is defined outside the adjustment range. Accordingly, the far range 12 can be defined in such a way that, due to the geometry of the closure element 3 and the adjustment kinematics, a collision with objects in the far range 12 is also unlikely regardless of the position of the closure element. In FIGS. 2 and 3, zone C lies outside the adjustment range and is defined as the far range 12.

The check routine can be modified in such a way that with a higher, assigned collision risk, a lower detection probability of a valid operator action is achieved than with a lower, assigned collision risk. The probability of detection is generally a measure of the sensitivity of the detection as a valid operator action. Higher requirements are placed on the existence of a valid operator action with a higher risk of collision than with a lower risk of collision. For example, the compliance of the detected operator action with a specification for a valid operator action is checked, wherein a higher degree of compliance is required for a higher risk of collision than for a lower risk of collision.

In one embodiment, it is provided that an operator action model with characteristic values is assigned to the valid operator action, that the control arrangement is used in the check routine to check whether the sensor values correspond to the characteristic values of the operator action model and that the operator action model is generated and/or parameterized depending on the relation of the closure element position to the execution position, taking into account the intended adjustment direction.

Such an operator action model can represent the shape or the course of the sensor values during the execution of an operator action. In particular, the characteristic values can be determined from a time dependency of the sensor values, for example as an average value, as a width, as a height, as an edge steepness and/or as a curvature of parts of a pulse in the sensor values caused by the operator action. In various embodiments, several spaced-apart sensor elements of the sensor arrangement 7 are provided, wherein a characteristic value is defined as the time offset of the sensor pulses of the sensor elements.

Generating the operator action model means that the characteristic values to be included in the evaluation are selected on the basis of the relation, taking into account the intended adjustment direction. By modifying the parameterization, for example, the weighting of the characteristic values in the evaluation is changed.

In particular, the characteristic values can be used to determine a recognition quality for the detected operator action, wherein the operator action is classified as a valid operator action or rejected on the basis of the recognition quality. The determination of the detection quality and/or at least one threshold value for the detection quality can be modified depending on the relation of the closure element position to the execution position, taking into account the intended adjustment direction. The detection quality can be a quantitative measure for the correspondence of the detected operator action with a specification for the valid operator action. A higher threshold value can be utilized for a higher risk of collision than for a low risk of collision.

Other embodiments of the check routine and their modification are conceivable. In particular, it may be provided that the sensor values are fed to a trained machine learning model as input values in the check routine and that the presence of a valid operator action is assessed on the basis of at least one output value of the trained machine learning model. The trained machine learning model is based, for example, on a support vector machine or similar and can be generated with a training data set that contains sensor values for valid and invalid operator actions.

The trained machine learning model and/or the input values can be dependent on the relation of the closure element position to the execution position, taking into account the intended adjustment direction. For example, several trained machine learning models are stored for different detection probabilities, wherein in particular one of the trained machine learning models is selected depending on the collision risk present for the execution position.

According to a further teaching, a control arrangement 6 for a closure element arrangement 1 of a motor vehicle 2 is proposed, wherein the control arrangement 6 is coupled in the mounted state to a sensor arrangement 7, which detects sensor values in a detection zone 8 with respect to an operator action carried out by an operator 9 outside the motor vehicle 2, wherein the control arrangement 6 checks the detected sensor values in a check routine for the presence of a valid operator action, wherein the control arrangement 6 causes a drive arrangement 4 of the closure element arrangement 1 to adjust a closure element 3 of the motor vehicle 2 in an adjustment direction when a valid operator action is present, and wherein the control arrangement 6 determines a closure element position of the closure element 3.

It is provided here that the control arrangement 6 modifies the check routine depending on a relation of the closure element position to an execution position of the detected operator action determined on the basis of the sensor values, taking into account the intended adjustment direction. Reference may be made to all explanations relating to the proposed method.

According to a further teaching, a closure element arrangement 1 for a motor vehicle 2 is proposed, wherein the closure element arrangement 1 is set up to carry out the proposed method. The closure element arrangement 1 can have the proposed control arrangement 6. Reference may be made to all comments relating to the proposed method and the proposed control arrangement 6.

1. A method for operating a closure element arrangement of a motor vehicle, the closure element arrangement comprising a closure element, a drive arrangement assigned to the closure element for displacing the closure element in an adjustment range, and a control arrangement for actuating the drive arrangement,
sensor values being detected by a sensor arrangement in a detection zone with respect to an operator action carried out by an operator outside the motor vehicle, the detected sensor values being checked by the control arrangement in a check routine for the presence of a valid operator action, and, if a valid operator action is present, the drive arrangement being caused by the control arrangement to displace the closure element in a displacement direction, and a closure element position of the closure element being determined by the control arrangement,
wherein the check routine is modified by the control arrangement depending on a relation of the closure element position to an execution position of the detected operator action determined on the basis of the sensor values, taking into account the intended adjustment direction.

2. The method as claimed in claim 1, wherein a collision risk is assigned to positions in the detection zone relative to the closure element position by the control arrangement, taking into account the intended adjustment direction, and wherein the check routine is modified depending on the collision risk assigned to the execution position.

3. The method as claimed in claim 2, wherein, starting from the closure element position, a greater risk of collision is assigned to positions close to the closure element position in the direction of displacement than to positions remote from the closure element position.

4. The method as claimed in claim 2, wherein a danger zone located at the closure element position is defined by the control arrangement in the detection zone, taking into account the intended adjustment direction, and wherein positions within the danger zone are assigned a higher risk of collision than positions outside the danger zone.

5. The method as claimed in claim 4, wherein the adjustment range is divided into the danger zone and a distance zone, and wherein positions within the danger zone are assigned a higher risk of collision than positions in the distance zone.

6. The method as claimed in claim 2, wherein a far range is defined in the detection zone , and wherein positions within the far range are assigned a lower risk of collision than positions outside the far range.

7. The method as claimed in claim 2, wherein the check routine is modified in such a way that a lower probability of detection of a valid operator action is achieved with a higher, assigned collision risk than with a lower, assigned collision risk.

8. The method as claimed in claim 1, wherein an operator action model with characteristic values is assigned to the valid operator action, wherein it is checked by the control arrangement as part of the check routine whether the sensor values correspond to the characteristic values of the operator action model, and wherein the operator action model is generated and/or parameterized as a function of the relation of the closure element position to the execution position, taking into account the intended adjustment direction.

9. The method as claimed in claim 8, wherein a recognition quality for the detected operator action is determined on the basis of the characteristic values of the set of characteristic values, wherein the operator action is classified as a valid operator action or rejected on the basis of the recognition quality, and wherein the determination of the recognition quality and/or at least one threshold value for the recognition quality is modified as a function of the relation of the closure element position to the execution position, taking into account the intended adjustment direction.

10. The method as claimed in claim 1, wherein in the check routine the sensor values are fed as input values to a trained machine learning model, wherein the presence of a valid operator action is assessed on the basis of at least one output value of the trained machine learning model, and wherein the trained machine learning model and/or the input values is or are dependent on the relation of the closure element position to the execution position, taking into account the intended adjustment direction.

11. A control arrangement for a closure element arrangement of a motor vehicle, the control arrangement being coupled in the assembled state to a sensor arrangement which detects sensor values in a detection zone with respect to an operator action carried out by an operator outside the motor vehicle, the control arrangement checking the detected sensor values in a check routine for the presence of a valid operator action, the control arrangement causing a drive arrangement of the closure element arrangement to adjust a closure element of the motor vehicle in an adjustment direction when a valid operator action is present, and the control arrangement determining a closure element position of the closure element,
wherein the control arrangement modifies the check routine depending on a relation of the closure element position to an execution position of the detected operator action determined on the basis of the sensor values, taking into account the intended adjustment direction.

12. The closure element arrangement for a motor vehicle, the closure element arrangement being set up to carry out the method as claimed in claim 1.

13. The method as claimed in claim 3, wherein, starting from the closure element position, a lower risk of collision is assigned to positions opposite the direction of displacement than to positions in the direction of displacement.

14. The method as claimed in claim 6, wherein the far range is defined outside the adjustment range.
